(19) United States
(12) Patent Application Publication
(10) Pub. No.: US 2024/0316672 A1
(43) Pub. Date: Sep. 26, 2024

(54) REGULATION OF ARC CHARACTERISTICS IN PULSED GAS METAL ARC WELDING

(71) Applicant: The ESAB Group, Inc., North Bethesda, MD (US)

(72) Inventors: Rastislav Kubicek, Göteborg (SE); Daniel Karlsson, Kungsängen (SE)

(21) Appl. No.: 18/595,653

(22) Filed: Mar. 5, 2024

Related U.S. Application Data
(60) Provisional application No. 63/491,800, filed on Mar. 23, 2023.

(51) Int. Cl. B23K 9/10; B23K 9/09; B23K 9/095; B23K 9/16

(52) U.S. Cl. CPC B23K 9/1012; B23K 9/09; B23K 9/0953; B23K 9/16

(57) ABSTRACT

An apparatus comprises: a power supply to generate a pulsed current waveform defined by current waveform parameters for an arc welding process; and a control module configured to present, and to receive selections of, selectable settings that vary over a dynamic range to control values of the current waveform parameters, wherein the selectable settings include a nominal setting that corresponds to nominal values of the current waveform parameters, and wherein the control module is configured to, upon receiving a selection of each selectable setting that differs from the nominal setting, cause the power supply to automatically adjust the values in combination relative to the nominal values according to a variation scheme as a function of each selectable setting over the dynamic range.

### CLAIM TO PRIORITY

This application claims priority to U.S. Provisional Application No. 63/491,800, filed Mar. 23, 2023, the entirety of which is incorporated herein by reference.

### TECHNICAL FIELD

The present disclosure relates to regulating arc characteristics in pulsed arc welding.

### BACKGROUND

Pulsed gas metal arc welding (GMAW-P), including pulsed metal inert gas (MIG) and pulsed metal active gas (MAG) welding, is a commonly used welding process that provides high-quality, low-spatter welds with a variety of wire electrode materials. A pulsed current waveform supplied by a welding power source causes the welding arc current to periodically fluctuate between a peak value and a lower, background value, with each current pulse releasing a molten droplet from the wire electrode, which transfers to a workpiece being welded. The shape and parameters of the pulsed current waveform, such as pulse frequency and duration, peak current, pulse energy, etc., influence physical aspects of the weld metal transfer and arc characteristics. Often, nominal current waveform parameters are selected synergically based on factors such as the wire electrode material (filler material), wire diameter, shielding gas composition, and wire feed speed. Owing to variables such as the desired arc energy and weld penetration depth, the desired weld arc width, weld travel speed, torch angle, and the skill level of the welder, no single set of parameters for defining the pulsed current waveform shape is suitable for all circumstances in which GMAW-P may be used. It would be beneficial to enable a welding operator to selectively adjust a number of current waveform parameters in concert automatically relative to nominal values to achieve desired arc energy and droplet control suitable for particular circumstances.

### BRIEF DESCRIPTION OF THE DRAWINGS

FIG. 1 is an illustration of an example welding system in which embodiments directed to regulation of arc characteristics in pulsed gas metal arc welding (GMAW-P) may be implemented.

FIG. 2 is a block diagram of an example power supply and an example power supply controller (PSC) of the welding system of FIG. 1.

FIG. 3 is an image of an electric arc between a wire electrode and a workpiece in a GMAW-P welding process, illustrating arc characteristics related to determination of arc energy density.

FIG. 4 is a graph illustrating current waveform parameters of a current pulse in a GMAW-P current waveform suitable for a stainless steel wire electrode material.

FIG. 5 is a graph illustrating variation of the primary and secondary current waveform parameters over a user-selectable dynamic range for a stainless steel wire electrode material.

FIG. 6 is a timeline graph overlaying three series of current pulses for three different dynamic settings of current waveform parameters for a stainless steel wire electrode material to illustrate the resulting variations in current waveform shapes and periodicity.

FIG. 7 is a graph illustrating current waveform parameters of a current pulse in a GMAW-P current waveform suitable for a carbon steel wire electrode material.

FIG. 8 is a graph illustrating variation of the primary and secondary current waveform parameters over a user-selectable dynamic range for a carbon steel wire electrode material.

FIG. 9 is a timeline graph overlaying three series of current pulses for three different dynamic settings of current waveform parameters for a carbon steel wire electrode material to illustrate the resulting variations in current waveform shapes and periodicity.

FIG. 10 is an illustration of an example human machine interface (HMI) used in the welding system.

FIG. 11 is a flowchart of an example method of regulating current waveform parameters of a current waveform based on user-selectable settings.

FIG. 12 is a block diagram of the PSC (also referred to as a “controller”) according to an embodiment.

### DETAILED DESCRIPTION

### Overview

In an embodiment, an apparatus comprises a power supply to generate a pulsed current waveform defined by current waveform parameters for an arc welding process; and a control module configured to present, and to receive selections of, selectable settings that vary over a dynamic range to control values of the current waveform parameters, wherein the selectable settings include a nominal setting that corresponds to nominal values of the current waveform parameters, and wherein the control module is configured to, upon receiving a selection of each selectable setting that differs from the nominal setting, cause the power supply to automatically adjust the values in combination relative to the nominal values according to a variation scheme as a function of each selectable setting over the dynamic range.

### Example Embodiments

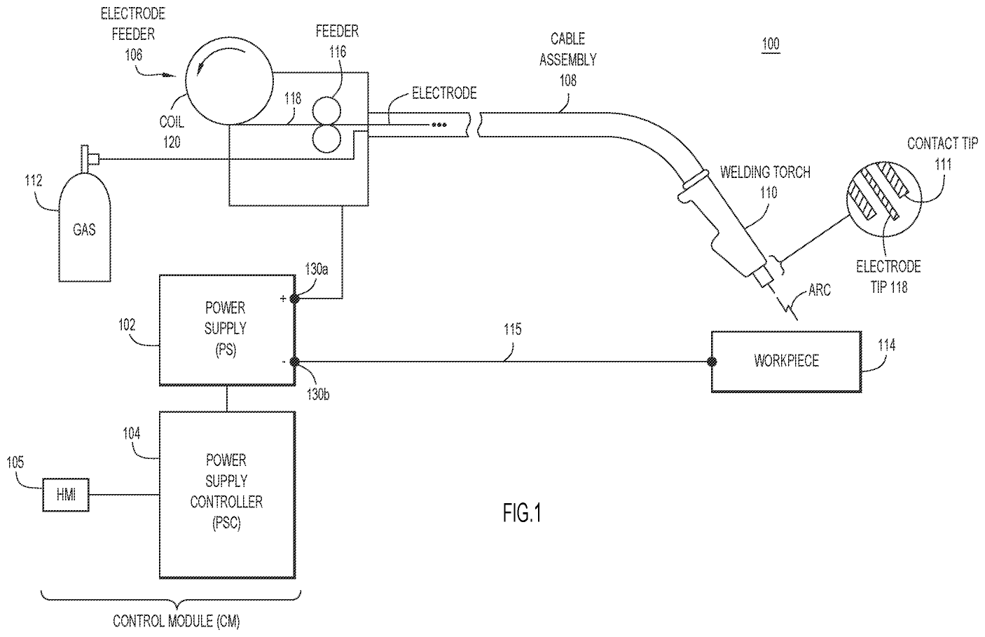

With reference to FIG. 1, there is an illustration of an example a GMAW (e.g., MIG/MAG) welding system 100, in which regulation of arc characteristics in a pulsed GMAW welding process may be implemented according to the described concepts. The embodiments are described in the context of the pulsed GMAW welding process, by way of example only. It is understood that the embodiments may be employed more generally in any pulsed arc welding process. In the example shown in FIG. 1, welding system 100 includes: a power supply 102; a power supply controller (PSC) 104 coupled to and configured to control the power supply; a human machine interface (HMI) 105 coupled to the PSC and through which a human interacts with and controls the welding system; a wire electrode feeder 106 coupled to the power supply; a cable assembly 108 coupled to the wire electrode feeder 106; a torch 110 coupled to the cable assembly 108 and having a sturdy metal contact tip 111 that extends from an end of the torch 110; a gas container 112 coupled to the cable assembly 108; and a workpiece 114 coupled to the power supply through at least a return path/cable 115. PSC 104 and HMI 105 collectively form a control module CM. In the ensuing description, the terms “weld” and “welding” are synonymous and interchangeable. In the context of arc welding, torch 110 may be referred to as a “welding torch” or “welding gun.”

Wire electrode feeder 106 includes a feeder 116 to feed a consumable electrode from a coiled wire electrode 120 through cable assembly 108 and through contact tip 111 of torch 110, which is in electrical contact with the electrode. Under control of PSC 104, power supply 102 generates weld power that drives the welding process/operation. In welding operations that involve a pulsed or periodic waveform, the weld power typically includes a series of weld current pulses. Power supply 102 provides the weld power from an output terminal 130a of the power supply to the wire electrode, through feeder 116, cable assembly 108, and torch 110, while the cable assembly 108 also delivers a shielding gas from gas container 112 to the torch. Return path/cable 115 provides an electrical return path from workpiece 114 to an input terminal 130b of power supply 102. The aforementioned components comprise a circuit path or weld circuit from output terminal 130a to input terminal 130b of power supply 102, through wire electrode feeder 106, cable assembly 108, torch 110, workpiece 114, and return path/cable 115.

During a welding operation, an electrode tip 118 of the electrode is brought into contact or near contact with workpiece 114, and the weld power (i.e., current and voltage) supplied by power supply 102 to the torch 110 creates an arc between workpiece 114 and electrode tip 118 extending through the contact tip. To control the welding process, PSC 104 controls power supply 102 to generate the weld power (e.g., current) at a desired level for the welding process, based on feedback in the form of measurements of the current and voltage (e.g., arc voltage) supplied by the power supply to the welding process. The measurements may be produced by current and voltage sense points in power supply 102 and/or at sense points that are remote from the power supply, such as in cable assembly 108 or torch 110. When welding system 100 is operated in a pulsed GMAW mode, power supply 102 supplies to the torch 110 a current waveform that periodically fluctuates between a low, background current, and a peak current level. Each current pulse begins with an upslope from the background current level to the peak current level and ends with a slope down from the peak current level. As described in greater detail below, the shape, duration, energy, and frequency of each current pulse are adjustable according to primary and secondary current waveform parameters that are controllable by power supply 102.

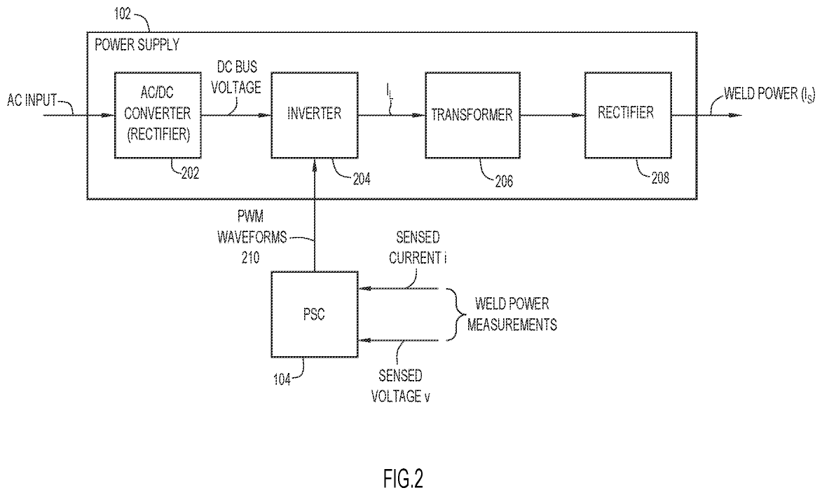

FIG. 2 is a block diagram of an example power supply 102 with PSC 104, according to an embodiment. Power supply 102 includes an AC/DC converter 202 to receive AC input power (e.g., from AC mains or a generator), a power inverter (referred to simply as an “inverter”) 204, a high-frequency transformer 206, and a rectifier 208 coupled to one another. AC/DC converter 202 includes, for example, a diode rectifier to convert the AC input power to a constant, rectified DC voltage (also referred to as a DC “bus” voltage), and provides the DC bus voltage to an input of inverter 204. Under control of PSC 104, inverter 204, transformer 206, and rectifier 208 collectively operate as a weld process regulator to convert the DC bus voltage to a desired weld power supplied by power supply 102 for a welding operation.

Inverter 204 comprises a set of high-speed semiconductor switching devices (i.e., power switches) that are pulse width modulated (i.e., switched on and off at a switching frequency) responsive to pulse width modulation (PWM) waveforms 210 (also referred to as “PWM signals”), generated by PSC 104 and applied to control terminals of the switching devices, to convert the DC bus voltage to an AC (power) signal or waveform including a voltage and a primary current I_{L} that flows into transformer 206. Such operation is referred to as “PWM operation” of inverter 204. Inverter 204 may include a four-quadrant inverter, such as an H-bridge inverter, for example. In other examples, other types of inverters may be employed. Example switching frequencies may be in a range from 1 kHz-100 kHz, although other switching frequencies above and below this range may be used. Inverter 204 supplies the AC signal to transformer 206. Transformer 206 converts the voltage and current of the AC signal from inverter 204 to a transformed AC signal having desired levels of a voltage and a secondary current Is for the welding operation, and supplies the transformed AC signal to rectifier 208. Rectifier 208 rectifies the transformed AC signal to produce the weld power and supplies the same to the welding process.

Welding system 100 includes a current sense point to provide a sensed or measured current i to PSC 104. Current i is indicative of the weld current supplied to weld torch 110 during a weld operation and when welding system 100 is idle and not actively engaged in the welding operation. Welding system 100 includes a voltage sense point to provide a sensed or measured voltage v to PSC 104. Voltage vis indicative of the weld voltage supplied to weld torch 110 during a weld operation and when power supply is welding system 100 is idle and not actively engaged in the welding operation. The current and voltage sense points may be located in or near the sequential stages of power supply 102, or may be implemented remotely from the power supply. Together, current i and voltage v represent measurements of weld power supplied by power supply 102 to torch 110 for a welding process. That is, together, current i and voltage v represent weld power measurements. To control the weld power generated by power supply 102, PSC 104 generates and controls (e.g., dynamically adjusts) PWM waveforms 210 applied to inverter 204 based at least in part on the weld power measurements. For example, PSC 104 may increase duty cycles and thus on-times of PWM waveforms 210 applied to inverter 204 to increase the weld power, and vice versa. In this way, power supply 102 and PSC 104 implement a feedback control loop to control PWM waveforms 210 based on current i and voltage v.

The described technique enables regulating dynamic characteristics of an electric arc in pulsed gas metal arc welding using stainless steel or carbon steel filler material in the form of a wire electrode and can be implemented in a welding power source such as that shown in FIGS. 1 and 2, for example, to enable a user to control the output of the weld process and to benefit in terms of optimizing welding performance quality in conjunction with a specific welding application having particular quality requirements on the weldment. In particular, the process involves regulating both primary and second parameters of the pulsed current waveform to enable precise and unique control of weld metal transfer in the electric arc and physical arc characteristics.

According to a described implementation, the technique employs specific combinations of the regulated parameters and percentage changes within a regulated dynamic range from a minimum value (i.e., minimum setting) to a maximum value (i.e., maximum setting). A “zero set value” represents the nominal, default values of the primary and secondary current waveform parameters at the center of the user-selectable dynamic range based on any of a variety of user inputs, such as a synergic set point based on several variables. The dynamic range over which the current waveform parameters can be adjusted extends from this “zero” point over a range of negative dynamic values to a minimum and over a range of positive dynamic values to a maximum. Each primary and secondary current waveform parameter is varied linearly as a function of the dynamic value over the negative range of values or over the positive range of values or over the entire range of values (both positive and negative values) such that, relative to the zero set values, variations to the current waveform parameters are greatest at the minimum and maximum values of the dynamic range.

Two important aspects of qualitative performance in GMAW-P are “weld metal transfer” during welding arc operation and “arc characteristics.” Quality as such must be defined in conjunction with a specific application in which the weld process is employed, so no generic definition of quality is feasible. Consequently, the described technique for modifying current waveform parameters provides the possibility of controlling arc characteristics and enabling the user to tune, adjust, or correct the output arc to obtain optimal results for whatever specific application, welding conditions, or quality requirements apply.

As described in greater detail below, the disclosed technique for regulating the pulsed current waveform of a pulsed welding process provides unique control over weld metal transfer and arc characteristics during the welding process, allowing the welding operator to use such regulation by setting a value on a dynamic (unitless) scale from a negative value (e.g., −9) to a positive value (e.g., +9) relative to a zero set value point (0) to improve performance output of the process.

Through HMI 105, the welding operator can select via a user interface (e.g., via a graphical user interface, a knob, button, slider bar, etc.) a value over the dynamic range, and the HMI communicates the selection to PSC 104. Responsive to the selection (i.e., to the value that is selected), PSC 104 controls/causes the power supply to automatically adjust the primary and secondary current waveform parameters in combination according to a predetermined variation scheme as a function of the selected dynamic value to automatically regulate the combination of parameters collectively. In particular, each current waveform parameter varies linearly over at least some portion of the dynamic range relative to its zero set value to automatically generate a programmed combination of parameters. Thus, a single setting value modifies primary and secondary current waveform parameters in combination. The modified current waveform consequently influences certain relevant physical aspects of weld metal transfer in the electric arc and the arc energy characteristics and, as a result, the overall performance output. A more detailed technical explanation of two of the more relevant aspects of the welding process is now described.

### Influence on Physical Aspects of Weld Metal Transfer

Changes in the welding current waveform influence the balance in the physical forces acting on the electric welding arc in conjunction with the static force balance theory model (generally scientifically accepted model that describes behavior of forces acting during liquid weld metal droplet detachment and free-flight phases). The physical outcome of several different forces acting simultaneously during the operation of electric arc in GMAW-P and their instant physical balance during arc operation will determine certain physical aspects of weld metal transfer and arc characteristics. The described technique enables controlling qualitative arc performance outputs to allow the user to benefit in a variety of applications, welding conditions, using specific welding techniques, base material conditions, and/or welding parameters.

In particular, physical aspects of weld metal transfer controllable by the described technique are:
droplet detachment height;
wire tapering length; and
plasma attachment height.

### Influence on the Characteristics of the Electric Arc

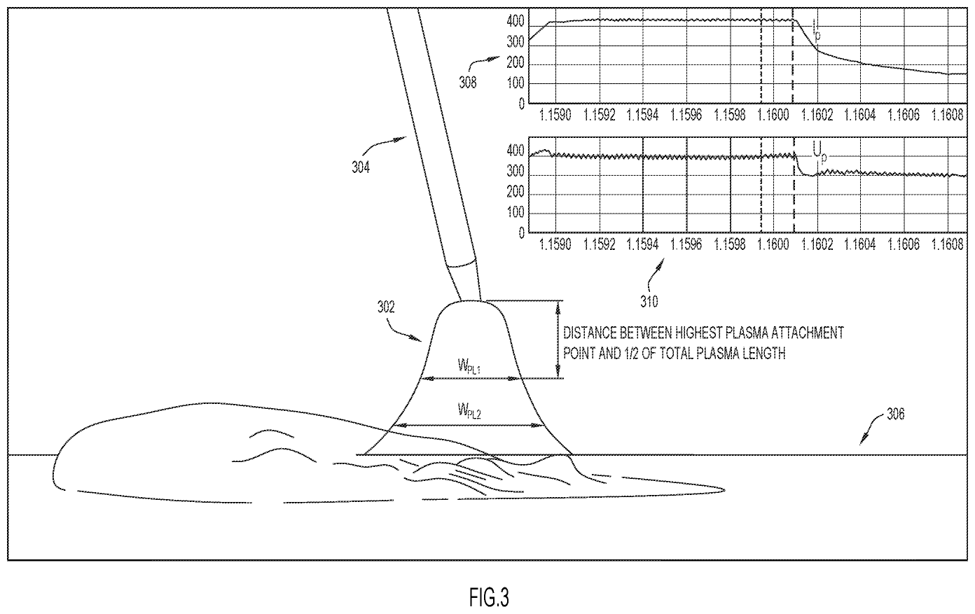

Changes in the welding current waveform also influence the arc characteristics in terms of the arc's geometrical proportions and arc energy density. Common parameters which generally describe arc geometrical proportions in conjunction with arc characteristics are the width and length of the plasma column. Arc energy density can be calculated according to equation (1) in conjunction with FIG. 3, showing an image of an electric arc 302 (i.e., a plasma column) between a wire electrode 304 and a workpiece 306 in a GMAW-P welding process. In addition, the upper right corner of FIG. 3 shows waveforms for a current 308 and a voltage 310 coincident with electric arc 302.

$$Arc energy density = \frac{Ip \cdot Up}{π \cdot {( \frac{{WPL}_{1} + {WPL}_{2}}{4} )}^{2}} ( W / mm2 ) \qquad ( 1 )$$

Where:
Iₚ is the pulse current value during peak period of current 308;
Uₚ is the pulse voltage value during peak period of voltage 310; and
WPL₁/WPL₂ is the ratio of the plasma column widths measured in two different levels with respect to plasma height, measured from image data in the time of highest ionization potential of the plasma.

In particular, arc characteristics controllable by the described technique are:
Width of the plasma column; and
Arc energy density.

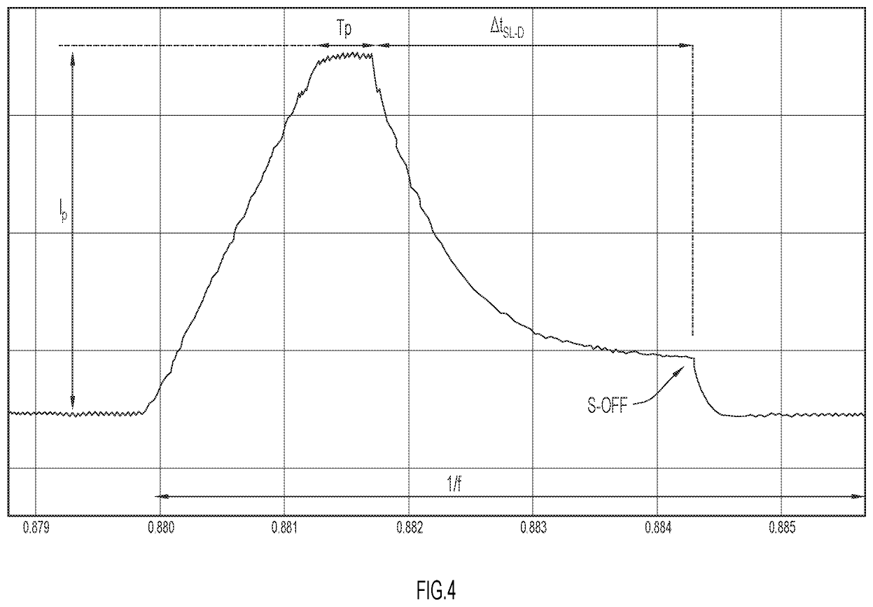

FIG. 4 is a graph illustrating current waveform parameters of a current pulse in a GMAW-P current waveform suitable for a stainless steel wire electrode material (stainless steel filler material). Stainless steel filler material will be understood to include a wide range of stainless steel wire grades, diameters, and protective gas mixtures. From a relatively low background current, the current pulse slopes up to a peak current, remains at the peak current for a period of time, slopes down to a base or “step-off” current that is higher than the background current, and finally drops rapidly from the step-off current to the background current. I_{P} denotes the peak current amperage of the current pulse, and variations in the peak current, denoted by ΔI_{P}, can be expressed as a percentage difference relative to the zero set value of I_{P}. T_{P} denotes the period of time (duration) that a current pulse remains at the peak current (or simply “peak current time”), and variations in the peak current time, denoted by ΔT_{P}, can be expressed as a percentage difference relative to the zero set value of T_{P}. The pulse period is the period of time from the beginning of one current pulse to the beginning of the next current pulse. The pulsed current frequency f is the reciprocal of the pulse period, and variations in the pulsed current frequency, denoted by Δf, can be expressed as a percentage difference relative to the zero set value of the pulsed current frequency f. In this description, the peak current I_{P}, the peak current time T_{P}, and the pulse current frequency fare primary current waveform parameters that are regulated/adjusted for both stainless steel and carbon steel wire electrode filler materials according to the described technique.

As shown in FIG. 4, T_{SL-D} is the current slope down time, i.e., the period of time from the end of the peak current time to the step-off current point, and variations in the current slope down time, denoted by ΔT_{SL-D}, can be expressed as a percentage difference relative to the zero set value of T_{SL-D}. S-OFF denotes the base or “step-off” current amperage, and variations in the step-off current, denoted by Δ_{S-OFF}, can be expressed as a percentage difference relative to the zero set value of S-OFF. In this description, the current slope down time T_{SL-D} and the step-off current amperage S-OFF are secondary current waveform parameters that are regulated/adjusted for stainless steel wire electrode filler materials according to the described technique. The current slope down time T_{SL-D} is a secondary current waveform parameter that is regulated/adjusted for carbon steel wire electrode filler materials according to the described technique.

Table 1 lists the combined adjustment scheme of the current waveform parameters and their percentage variations over the regulated dynamic range for a stainless steel wire electrode filler material. The information presented in Table 1 is an example of a predetermined variation scheme as a function of the selected dynamic value use to automatically regulate the combination of parameters collectively, mentioned above. The information stored in Table 1 may be stored in PSC 104 and accessed responsive to receiving selections of setting values, as described below. As used herein, the terms “setting(s),” “setting value(s),” and “set value(s)” are synonymous and may be used interchangeably. At “0” in the center of the dynamic range, each of the primary and secondary current waveform parameters remain at the zero set value. Note that the zero set values of the primary and secondary parameters may themselves vary from weld to weld based on any of a variety of user-selectable or synergically determined weld parameters such as wire electrode filler material, wire diameter, shielding gas composition, wire feed speed, and user-selected welding power parameters. The zero set values of the current waveform parameters may also vary over time as a result of arc length control regulation, which attempts to maintain a constant arc length by providing feedback on arc power characteristics to the power source to enable suitable adjustments to the weld power supplied by the power source. In this example, the selectable dynamic range values span from a minimum value (i.e., minimum setting) of “−9” to a maximum value (i.e., maximum setting) of “+9.” It will be appreciated that any suitable range of dynamic values can be employed so long as the waveform current parameters, each of which is adjusted linearly over at least portion of the dynamic range, are adjustable with an acceptable degree of granularity. In this case, 19 selectable integer (discrete) values are available to the weld operator, providing a significant degree of gradation of the parameters across the dynamic range.

TABLE 1
Combined Adjustment Scheme for Current Waveform
Parameters for Stainless Steel Filler Material

| | | | Regulated percent change of | |
|---|---|---|---|---|
| | | | parameter at min and max | |
| Regulated current | | | range of the scale | |
| waveform parameter | | Description of parameter | “−9” | “+9” |
| Primary | Δf | Change of pulsed current frequency | −12% | +8% |
| parameter | ΔT_{P} | Change of peak current time during a | 0% | +10% |
| | | pulse | | |
| | ΔI_{P} | Change of peak current amperage | +8% | 0% |
| Secondary | ΔT_{SL-D} | Change of current slope-down time (time | +33% | 0% |
| parameter | | from the end of the peak current period | | |
| | | until step-off current point) | | |
| | Δ_{S-OFF} | Change of base current amperage (also | 0% | −37% |
| | | called step-off current) | | |

As shown in Table 1, the change in the pulsed current frequency Δf, relative to the zero set value of the pulsed current frequency f, is −12% at the dynamic value −9, and varies linearly from −12% to 0% between dynamic values −9 and 0 (e.g., at the dynamic value −3, Δf=−4%). The change in the pulsed current frequency Δf, relative to the zero set value of the pulsed current frequency f, is 8% at the dynamic value 9, and varies linearly from 0% to 8% between dynamic values 0 and 9 (e.g., at the dynamic value 3, Δf=2.67%). Thus, the pulsed current frequency f varies according to a first positive slope over the range of negative dynamic values and varies according to a second, lower magnitude positive slope over the range of positive dynamic values.

For negative dynamic values (i.e., from −9 to 0), the peak current time T_{P} does not vary (ΔT_{P}=0 over the negative range) and remains at the zero set value of the peak current time T_{P}. The change in the peak current time ΔT_{P}, relative to the zero set value of the peak current time T_{P}, is 10% at the dynamic value 9, and varies linearly from 0% to 10% between dynamic values 0 and 9 (e.g., at the dynamic value 3, ΔT_{P}=3.33%). Thus, the peak current time T_{P} does not vary (slope of zero) over the range of negative dynamic values and varies according to a positive slope over the range of positive dynamic values.

The change in the peak current ΔI_{P}, relative to the zero set value of the peak current I_{P}, is +8% at the dynamic value −9, and varies linearly from 8% to 0% between dynamic values −9 and 0 (e.g., at the dynamic value −3, ΔI_{P}=2.67%). For positive dynamic values (i.e., from 0 to 9), the peak current I_{P} does not vary (ΔI_{P}=0 over the positive dynamic range) and remains at the zero set value of the peak current I_{P}. Thus, the peak current I_{P} varies according to a negative slope over the range of negative dynamic values and does not vary (slope of zero) over the range of positive dynamic values.

Still referring to Table 1, considering the secondary current waveform parameters, the change in the current slope down time ΔT_{SL-D}, relative to the zero set value of the current slope down time T_{SL-D}, is +33% at the dynamic value −9, and varies linearly from 33% to 0% between dynamic values −9 and 0 (e.g., at the dynamic value −3, ΔT_{SL-D}=11%). For positive dynamic values (i.e., from 0 to 9), the current slope down time T_{SL-D} does not vary (ΔT_{SL-D}=0 over the positive dynamic range) and remains at the zero set value of the current slope down time T_{SL-D}. Thus, the current slope down time T_{SL-D} varies according to a negative slope over the range of negative dynamic values and does not vary (slope of zero) over the range of positive dynamic values.

For negative dynamic values (i.e., from −9 to 0), the step-off current S-OFF does not vary (Δ_{S-OFF}=0 over the negative range) and remains at the zero set value of the step-off current S-OFF. The change in the step-off current Δ_{S-OFF}, relative to the zero set value of the step-off current S-OFF, is-37% at the dynamic value 9, and varies linearly from 0% to-37% between dynamic values 0 and 9 (e.g., at the dynamic value 3, Δ_{S-OFF}=−12.33%). Thus, the step-off current S-OFF does not vary (slope of zero) over the range of negative dynamic values and varies according to a negative slope over the range of positive dynamic values.

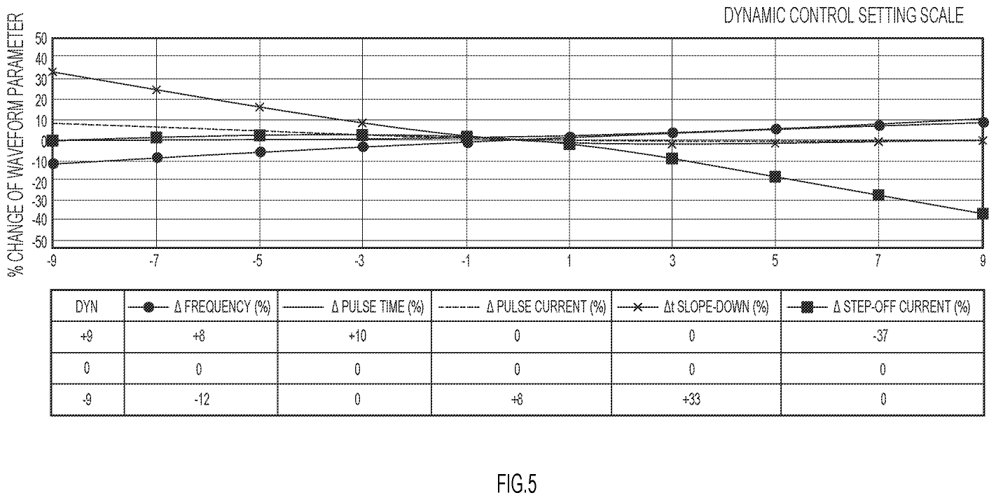

The example in Table 1 of a combined adjustment scheme of the current waveform parameters over the regulated user-adjustable dynamic range for a stainless steel wire electrode filler material is shown graphically in FIG. 5. As can be seen in FIG. 5, in this example, the dynamic range includes 19 discrete, selectable integer values over which the combination of current waveform parameters vary: −9, −8, −7, −6, −5, −4, −3, −2, −1, 0, +1, +2, +3, +4, +5, +6, +7, +8, and +9. The example set of combined current waveform parameter variations shown in Table 1 and FIG. 5 is suitable for a wide range of stainless steel wire grades, diameters, and protective gas mixtures. While the described implementation uses discrete, selectable dynamic values over a dynamic range, according to another option, the selection mechanism of the user interface can allow a continuum of selectable values over the dynamic range, e.g., via an analog interface such as a knob or slider bar.

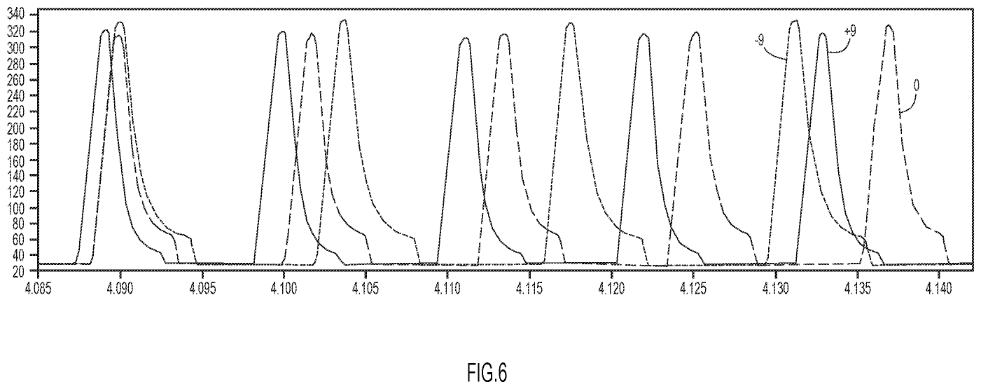

FIG. 6 is a timeline graph overlaying three series of current pulses for three different dynamic setting values (i.e., −9, 0, 9) of the current waveform parameters for a stainless steel wire electrode material to illustrate the variations in current waveform shapes and periodicity resulting from the parameter variations shown in Table 1 and FIG. 5. Note, for example, that at dynamic value −9, the changes to the current waveform parameters relative to the zero setting values result in current pulses with a higher peak current I_{P}, a longer duration owing to a greater current slope down time T_{SL-D}, and a lower pulsed current frequency f. This combination of current waveform parameter variations produces pulses having a greater concentration of energy than current pulses generated using the current waveform parameters having the zero set values. The parameter changes for negative dynamic settings in this example increase the energy density of the arc (the arc energy is more concentrated), which allow a welding operator to weld faster with better control of the arc and weld pool and to maintain more energy density for deeper penetration into workpiece material.

In contrast, at dynamic value +9, the changes to the current waveform parameters relative to the zero setting values result in current pulses with a longer peak current time T_{P}, a lower step-off current S-OFF, and a higher pulsed current frequency f. The parameter changes for positive dynamic settings in this example result in a wider arc with less concentrated energy, allowing greater control for situations where less aggressive or easier-to-handle welding is desired.

An important aspect of the described regulation concept is to maintain a constant power level of the weld process regardless of the selected dynamic value. More specifically, the average instantaneous power remains constant across the entire dynamic setting range (in the example, from −9 to +9). In other words, the overall weld energy over time, which is proportional to the area under the pulse “curves,” remains the same regardless of the dynamic setting value. This is true despite the fact that the individual pulse energy varies over the dynamic range. For example, at a dynamic setting value of −9, an individual pulse has considerably more energy than a single pulse generated from the current waveform parameter values having the zero set values. However, the increased energy of the individual pulses is offset by the lower pulsed current frequency f such that the overall energy over time (and the average power) remain the same. This characteristic of the combination of parameter variations avoids undesirable changes in the melting rate of a fed wire into the weld process and enables the arc length to be kept relatively constant (i.e., invariant and unaffected by the user selection of the dynamic setting value). In general, the described technique enables better control over the energy of the arc and droplet transfer, which aids in keeping the arc length constant.

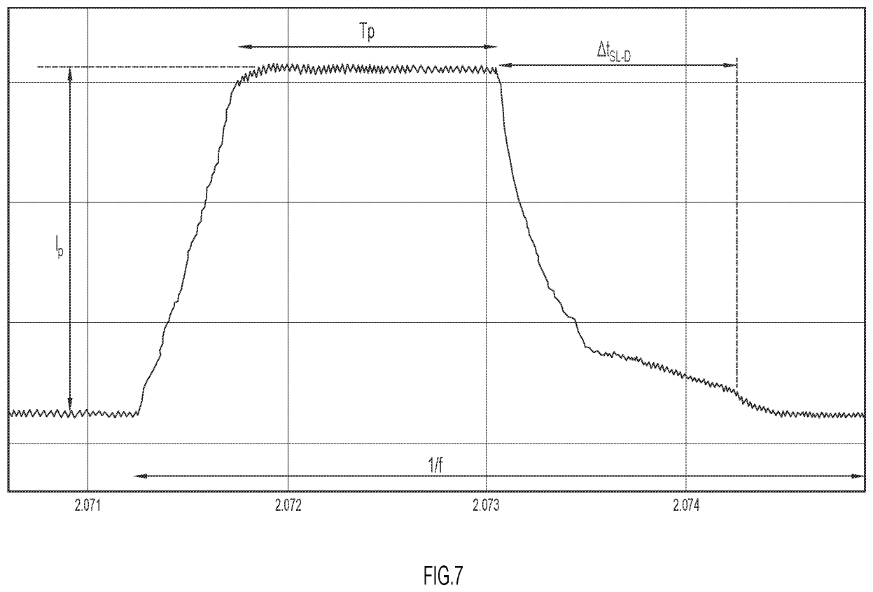

FIG. 7 is a graph illustrating current waveform parameters of a current pulse in a GMAW-P current waveform suitable for a carbon steel wire electrode filler material. Carbon steel filler material will be understood to include a wide range of carbon steel wire grades, diameters and protective gas mixtures, and techniques described herein are applicable for a wide range of carbon steel grades, diameters, and protective gas mixtures, providing relatively equally unique performance outcomes. From a relatively low background current, the current pulse slopes up to a peak current, remains at the peak current for a period of time, slopes down to a base or “step-off” current that is higher than the background current, and finally drops from the step-off current to the background current. As with the stainless steel example, I_{P} denotes the peak current amperage of the current pulse, and variations in the peak current, denoted by ΔI_{P}, can be expressed as a percentage difference relative to the zero set value of I_{P}. T_{P} denotes the period of time (duration) that a current pulse remains at the peak current (or simply “peak current time”), and variations in the peak current time, denoted by ΔT_{P}, can be expressed as a percentage difference relative to the zero set value of T_{P}. Note that, in relative terms, the pulse shape for carbon steel has a longer peak current time T_{P} compared to the overall duration of the pulse. As with the stainless steel example, the pulsed current frequency f is the reciprocal of the pulse period, and variations in the pulsed current frequency, denoted by Δf, can be expressed as a percentage difference relative to the zero set value of the pulsed current frequency f. As previously noted, the peak current I_{P}, the peak current time T_{P}, and the pulse current frequency f are primary current waveform parameters that are regulated/adjusted for carbon steel wire electrode filler materials according to the described technique.

As shown in FIG. 7, T_{SL-D} is the current slope down time, i.e., the period of time from the end of the peak current time to the step-off current point, and variations in the current slope down time, denoted by ΔT_{SL-D}, can be expressed as a percentage difference relative to the zero set value of the current slope down time T_{SL-D}. The pulse shape of the downslope for the carbon steel GMAW-P current pulse is less regular than that of the stainless steel pulse shape, and the step-off current level and transition is less pronounced. As previously noted, the current slope down time T_{SL-D} is a secondary current waveform parameter that is regulated/adjusted for carbon steel wire electrode filler materials according to the described technique.

Table 2 lists the combined adjustment scheme of the current waveform parameters and their percentage variations over the regulated dynamic range for a carbon steel wire electrode filler material. Specifically, at “0” in the center of the dynamic range, each of the primary and secondary current waveform parameters remains at the zero set value. As with example for stainless steel filler materials, the selectable dynamic range values for this carbon steel filler material example span from a minimum value of “−9” to a maximum value of “+9.” It will be appreciated that any suitable range of dynamic values can be employed so long as the waveform current parameters, each of which is adjusted linearly over at least portion of the dynamic range, are adjustable with an acceptable degree of granularity.

TABLE 2
Combined Adjustment Scheme for Current Waveform
Parameters for Carbon Steel Filler Material

| | | | Regulated percentage change | |
|---|---|---|---|---|
| | | | of parameter at min and max | |
| Regulated current | | | range of the scale | |
| waveform parameter | | Description of parameter | “−9” | “+9” |
| Primary | Δf | Change of pulsed current frequency | −8% | +6% |
| parameter | ΔT_{P} | Change of peak current time during a | 0% | +10% |
| | | pulse | | |
| | ΔI_{P} | Change of peak current amperage | +4% | 0% |
| Secondary | ΔT_{SL-D} | Change of current slope-down time (time | +33% | −16% |
| parameter | | from the end of the peak current period | | |
| | | until step-off current point) | | |

As shown in Table 2, the change in the pulsed current frequency Δf, relative to the zero set value of the pulsed current frequency f, is −8% at the dynamic value −9, and varies linearly from −8% to 0% between dynamic values −9 and 0 (e.g., at the dynamic value −3, Δf=−2.67). The change in the pulsed current frequency Δf, relative to the zero set value of the pulsed current frequency f, is 6% at the dynamic value 9, and varies linearly from 0% to 6% between dynamic values 0 and 9 (e.g., at the dynamic value 3, Δf=2%). Thus, the pulsed current frequency f varies according to a first positive slope over the range of negative dynamic values and varies according to a second, lower magnitude positive slope over the range of positive dynamic values.

For negative dynamic values (i.e., from −9 to 0), the peak current time T_{P} does not vary (ΔT_{P}=0 over the negative range) and remains at the zero set value of the peak current time T_{P}. The change in the peak current time ΔT_{P}, relative to the zero set value of the peak current time T_{P}, is 10% at the dynamic value 9, and varies linearly from 0% to 10% between dynamic values 0 and 9 (e.g., at the dynamic value 3, ΔT_{P}=3.33%). Thus, the peak current time T_{P} does not vary (slope of zero) over the range of negative dynamic values and varies according to a positive slope over the range of positive dynamic values.

The change in the peak current ΔI_{P}, relative to the zero set value of the peak current I_{P}, is +4% at the dynamic value −9, and varies linearly from 4% to 0% between dynamic values −9 and 0 (e.g., at the dynamic value −3, ΔI_{P}=1.33%). For positive dynamic values (i.e., from 0 to 9), the peak current I_{P} does not vary (ΔI_{P}=0 over the positive dynamic range) and remains at the zero set value of the peak current I_{P}. Thus, the peak current I_{P} varies according to a negative slope over the range of negative dynamic values and does not vary (slope of zero) over the range of positive dynamic values.

Still referring to Table 2, considering the secondary current waveform parameter, the change in the current slope down time ΔT_{SL-D}, relative to the zero set value of the current slope down time T_{SL-D}, is +33% at the dynamic value −9, and varies linearly from 33% to 0% between dynamic values −9 and 0 (e.g., at the dynamic value −3, ΔT_{SL-D}=11%). The change in the current slope down time ΔT_{SL-D}, relative to the zero set value of the current slope down time T_{SL-D}, is −16% at the dynamic value 9, and varies linearly from 0% to −16% between dynamic values 0 and 9 (e.g., at the dynamic value 3, ΔT_{SL-D}=−5.33%). Thus, the current slope down time T_{SL-D} varies according to a first negative slope over the range of negative dynamic values and varies according to a second, lower-magnitude negative slope over the range of positive dynamic values.

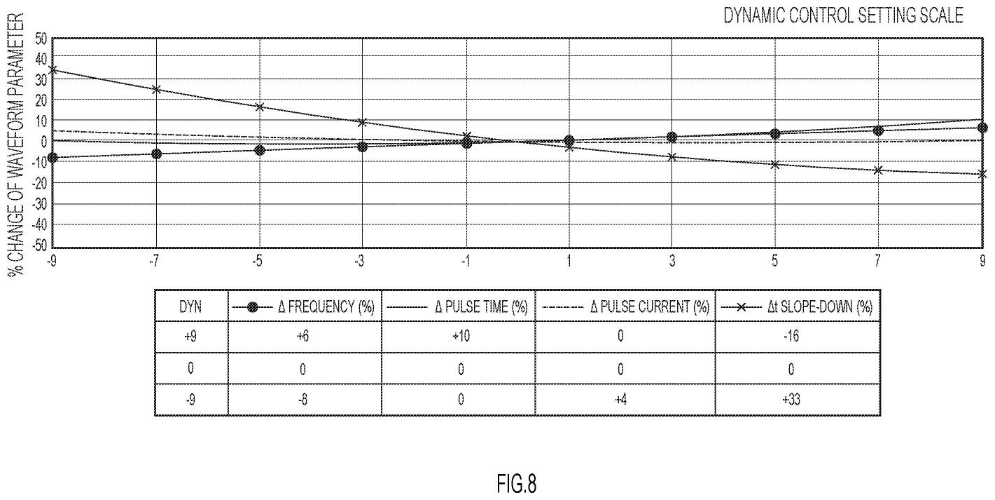

The example in Table 2 of a combined adjustment scheme of the current waveform parameters over the regulated dynamic range for a carbon steel wire electrode filler material is shown graphically in FIG. 8. As can be seen in FIG. 8, in this example, the dynamic range includes 19 selectable values over which the combination of current waveform parameters vary: −9, −8, −7, −6, −5, −4, −3, −2, −1, 0, +1, +2, +3, +4, +5, +6, +7, +8, and +9. The example set of combined current waveform parameter variations shown in Table 2 and FIG. 8 is suitable for a wide range of carbon steel wire grades, diameters, and protective gas mixtures. Here again, while this example is implemented with discrete selectable values over the dynamic range, another option involves using an analog selector (e.g., knob or sidebars) on the user interface to enable the use to select dynamic values continuously over the dynamic range.

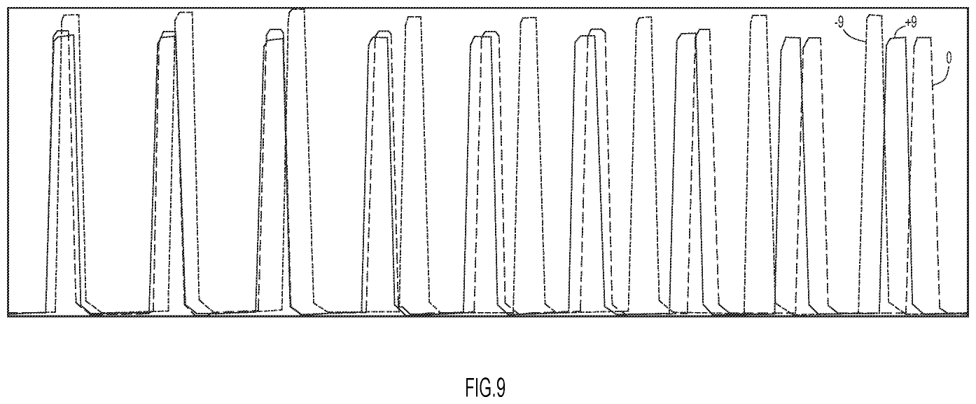

FIG. 9 is a timeline graph overlaying three series of current pulses for three different dynamic setting values (i.e., −9, 0, 9) of current waveform parameters for a carbon steel wire electrode material to illustrate the variations in current waveform shapes and periodicity resulting from the parameter variations shown in Table 2 and FIG. 8. Note, for example, that at dynamic value −9, the changes to the current waveform parameters relative to the zero setting values result in current pulses with a higher peak current I_{P}, a longer duration owing to a greater current slope down time T_{SL-D}, and lower pulsed current frequency f. This combination of current waveform parameter variations produces pulses having greater energy density than current pulses generated using the current waveform parameters having the zero set values. The parameter changes for negative dynamic settings in this example increase the energy density of the arc (the arc energy is more concentrated), which allow a welding operator to weld faster with better control of the arc and weld pool and to maintain more energy density for deeper penetration into workpiece material.

In contrast, at dynamic value +9, the changes to the current waveform parameters relative to the zero setting values result in current pulses with a longer peak current time T_{P}, a shorter slope-down time T_{SL-D} S-OFF, and a higher pulsed current frequency f. The parameter changes for positive dynamic settings in this example result in a wider arc with less concentrated energy, allowing greater control for situations where less aggressive or easier-to-handle welding is desired.

As with the stainless steel example, in this carbon steel implementation, a constant power level of the weld process is maintained regardless of the selected dynamic value. More specifically, the average instantaneous power remains constant across the entire dynamic setting range (in this example, from −9 to +9). In other words, the overall weld energy over time, which is proportional to the area under the pulse “curves,” remains the same regardless of the dynamic setting value. This is true despite the fact that the individual pulse energy varies over the dynamic range, thereby avoiding undesirable changes in the melting rate of fed wire into the weld process and enabling the arc length to be kept relatively constant (i.e., invariant and unaffected by the user selection of the dynamic setting value).

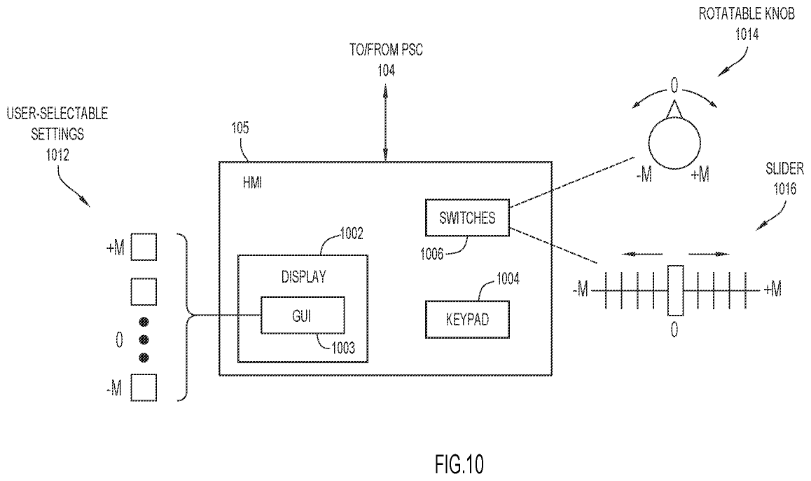

FIG. 10 is an illustration of HMI 105 according to an embodiment. In the example, HMI 105 includes a display 1002 (which may be configured to present a graphical user interface (GUI) 1003), an alphanumeric keypad 1004, and switches 1006 (e.g., an ON/OFF user switch and the like) through which the operator may interact with welding system 100. Through HMI 105, the operator may enter initial/nominal weld procedure information to initiate a weld procedure/process. The initial/nominal weld procedure information may establish nominal/zero values for current waveform parameters, as described above.

Display 1002 and GUI 1003 may present information to the operator, and receive selections of the information from the operator. For example, GUI 1003 may present (and receive selections of) user-selectable settings 1012 across a dynamic range of −M to +M (where M=9, 13, and so on, for example) of the user-selectable settings in order to selectively vary current pulse parameters relative to their nominal values across the dynamic range, as described above. Alternatively, or additionally, switches 1006 may include one or more electro-mechanical selectors, such as a rotatable knob 1014 that rotates to select the selectable settings, and/or a slider bar 1016 that slides to select the selectable settings. Other HMI arrangements are possible. For example, HMI 105 may be incorporated as part of a computer device, such as a personal computer (laptop, desktop), tablet computer, SmartPhone, and the like, with user input and output devices, such as a display, keyboard, mouse, and the like.

In summary, welding system 100 includes HMI 105, PSC 104, and power supply 102 coupled to each other. Power supply 102 generates a pulsed current waveform (the “current waveform”) defined by pulsed current waveform parameters (the “current waveform parameters”) for an arc welding operation under control of the HMI and the PSC (i.e., under control of control module CM). HMI 105 provides/presents user-selectable settings that are unitless and that can vary over a dynamic range from a minimum setting to a maximum setting. HMI 105 receives selections of the user-selectable settings (e.g., one at a time), and provides the same to PSC 104 as selected settings. PSC 104 includes/stores information (e.g., Tables 1 and 2) that maps or associates the user-selectable settings to corresponding information of a predetermined variation scheme that defines how to vary values of the current waveform parameters relative to nominal values of the current waveform parameters in combination for each of the user-selectable settings over the dynamic range. Thus, upon receiving a selection of a user-selectable setting HMI 105 (e.g., a selected setting), PSC can adjust the values of the current waveform parameters relative to their nominal values in accordance with the predetermined variation scheme and the selected setting.

Initially, HMI 105 receives the nominal values for the current waveform parameters, and provides the same to PSC 104. In response, PSC 104 causes power supply 102 to generate the current waveform parameters based on/with the nominal values.

Next, HMI 105 receives a selection of one of the user-selectable settings (i.e., a selected setting) that differs from the nominal setting, and communicates the same to PSC 104. In response, PSC 104 matches the selected setting to corresponding adjustment values for the current waveform parameters defined by the predetermined variation scheme. PSC 104 causes power supply 102 to automatically adjust the nominal values of the current waveform parameters (i.e., relative to the nominal values) in combination according to the adjustment values to produce new values, in order to regulate the current waveform parameters. Power supply 102 generates the current waveform with the new/adjusted current waveform parameters, i.e., the power supply generates a modified current waveform.

According to an embodiment, the predetermined variation scheme defines adjustments to the current waveform parameters relative to the nominal values for each selectable setting over the dynamic range. The predetermined variation scheme causes the power supply to adjust one or more of the current waveform parameters linearly with the selectable settings over a portion of the dynamic range (e.g., the predetermined variation scheme may define, for each current waveform parameter, first and second adjustment values (relative to each nominal value) for first and second user-selectable settings, and generate linearly varying intermediate adjustment values (relative to each nominal value) for intermediate user-selectable settings between the first and second user-selectable settings). The predetermined dynamic range has a negative range that includes negative settings of the selectable settings and a positive range that includes positive settings of the selectable settings and that straddle the zero setting of the selectable settings that corresponds to the nominal setting. The predetermined variation scheme adjusts a first current waveform parameter over only the negative range, and a second current waveform parameter over only the positive range. The predetermined variation scheme adjusts a third current waveform parameter over both the negative range and the positive range. The predetermined variation scheme defines adjustments of the current waveform parameters for each selectable setting so as maintain a constant average energy of the current waveform for each selectable setting across the dynamic range.

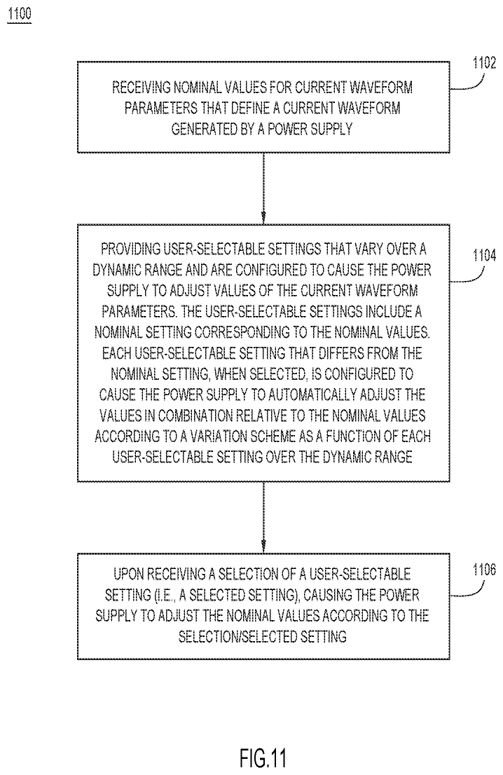

FIG. 11 is a flowchart of an example method 1100 of controlling a power supply configured to generate a pulsed current waveform defined by current waveform parameters for an arc welding process. In an embodiment, the current waveform parameters include primary and secondary waveform parameters that define a pulse shape for current pulses of the pulsed current waveform and a frequency of the current pulses (i.e., a current pulse frequency). Additionally, changes to the primary and current waveform parameters define/cause changes to the pulse shape and/or the frequency, as described above.

1102 includes receiving nominal values for the current waveform parameters and generating a current waveform based on the nominal values.

1104 includes providing user-selectable settings that vary over a dynamic range and are configured to cause the power supply to adjust values of the current waveform parameters. The user-selectable settings include a nominal setting corresponding to the nominal values. Each user-selectable setting that differs from the nominal setting, when selected, is configured to cause the power supply to automatically adjust the values in combination relative to the nominal values according to a variation scheme as a function of each user-selectable setting over the dynamic range.

1106 includes, upon receiving a selection of a user-selectable setting (i.e., a selected setting), causing the power supply to adjust the nominal values according to the selection/selected setting, and generating the current waveform with the adjusted values.

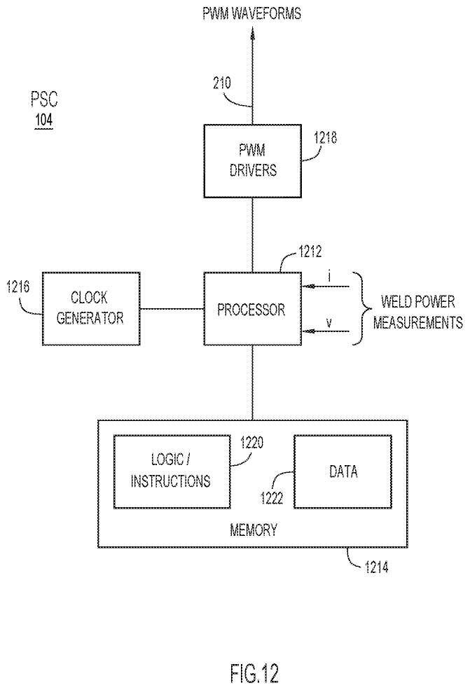

With reference to FIG. 12, there is a block diagram of PSC 104 (also referred to as a “controller”) according to an embodiment. PSC 104 includes a processor 1212 (e.g., a microcontroller) (which may be implemented in hardware, software, or a combination thereof), a memory 1214, a clock generator 1216, and PWM drivers 1218 coupled with each other. PSC 104 receives sensed voltage and current (i.e., voltage and current measurements), and weld power settings, and generates PWM waveforms 210 to control the current and voltage waveforms produced by power supply 102 responsive to the PWM signals. Memory 1214 stores non-transitory computer readable program instructions/logic instructions 1220 that, when executed by processor 1212, cause the controller to perform the operations described herein. Memory 1214 also stores data 1222 used and produced by processor 1212. Examples of data 1222 include values of waveform parameters and information that defines a predetermined variation scheme, as described above. Clock generator 1216 generates clocks and timing signals used to drive other components of PSC 104. In embodiments, components of PSC 104 may include electronic circuitry such as, for example, programmable logic circuitry, field-programmable gate arrays (FPGA), or programmable logic arrays (PLA) to execute the computer readable program instructions, which may include microcode, firmware, and so on.

In summary, the described technique provides a unique method of dynamic regulation of the electric arc in pulsed GMAW processes, enabling superior control of weld metal transfer and arc characteristics. Among the advantages provided by the described technique is the ability to adjust the electric arc energy density (expressed as the amount of the power per area (W/mm2)) and consequently the thermal effectivity of the arc applied by welding. Another advantage is the ability to correct arc stability and spatter avoidance when specific uncommon combinations of welding travel speed, CTWD (contact to work distance) and torch angles are applied in manual welding. A further advantage is the ability to adjust and control variation in the weld geometrical parameters, specifically weld bead shape coefficient (defined as weld bead height divided by weld bead width), penetration depth to the base material, wetting angles and convexity of the weld bead.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus, comprising:
a power supply to generate a pulsed current waveform defined by current waveform parameters for a pulsed arc welding process; and
a control module configured to present, and to receive selections of, selectable settings that vary over a dynamic range to control values of the current waveform parameters, wherein the selectable settings include a nominal setting that corresponds to nominal values of the current waveform parameters, and wherein the control module is configured to, upon receiving a selection of each selectable setting that differs from the nominal setting, cause the power supply to automatically adjust the values of the current waveform parameters in combination relative to the nominal values according to a variation scheme as a function of each selectable setting over the dynamic range.

2. The apparatus of claim 1, wherein:
the current waveform parameters define a pulse shape and a pulse frequency of the pulsed current waveform and the selection of each selectable setting that differs from the nominal setting causes the power supply to automatically adjust one or more of the pulse shape or the pulse frequency of the pulsed current waveform.

3. The apparatus of claim 1, wherein:
the variation scheme defines adjustments to the current waveform parameters relative to the nominal values of the current waveform parameters for each selectable setting over the dynamic range.

4. The apparatus of claim 1, wherein:
the variation scheme is configured to cause the power supply to adjust one or more of the current waveform parameters linearly with the selectable settings over a portion of the dynamic range.

5. The apparatus of claim 1, wherein:
the dynamic range includes a negative range that includes negative settings of the selectable settings and a positive range that includes positive settings of the selectable settings and that straddle a zero setting of the selectable settings that corresponds to the nominal setting.

6. The apparatus of claim 5, wherein the variation scheme is configured to adjust:
a first current waveform parameter over only the negative range; and
a second current waveform parameter over only the positive range.

7. The apparatus of claim 6, wherein the variation scheme is further configured to adjust:
a third current waveform parameter over both the negative range and the positive range.

8. The apparatus of claim 1, wherein:
the variation scheme defines adjustments of the current waveform parameters for each selectable setting so as maintain a constant average power of the pulsed current waveform for each selectable setting across the dynamic range.

9. The apparatus of claim 1, wherein:
the current waveform parameters include primary current waveform parameters that include a peak current value, a peak current time at which the peak current value is maintained, and a pulsed current frequency.

10. The apparatus of claim 9, wherein:
the current waveform parameters further include second current waveform parameters that include a current slope-down time from an end of the peak current time to a step-off current value.

11. The apparatus of claim 1, wherein the control module is configure to receive information that defines the nominal values of the current waveform parameters.

12. The apparatus of claim 1, wherein the control module includes:
a human machine interface (HMI) to present the selectable settings; and
a power supply controller coupled to the HMI and the power supply and configured to, upon receiving a selection of a selectable setting from the HMI, cause the power supply to adjust the values of the current waveform parameters according to the selection.

13. The apparatus of claim 12, wherein the HMI includes one of an electro-mechanical selector or a graphical user interface (GUI) that presents the selectable settings.

14. The apparatus of claim 13, wherein the pulsed current waveform is for pulsed gas metal arc welding (GMAW-P).

15. A method of controlling a power supply configured to generate a pulsed current waveform defined by current waveform parameters for an arc welding process:
receiving nominal values for the current waveform parameters;
providing selectable settings that vary over a dynamic range and are configured to cause the power supply to adjust values of the current waveform parameters, wherein the selectable settings include a nominal setting corresponding to the nominal values, wherein each selectable setting that differs from the nominal setting, when selected, is configured to cause the power supply to automatically adjust the values in combination relative to the nominal values according to a variation scheme as a function of each selectable setting over the dynamic range; and
upon receiving a selection of a selectable setting, cause the power supply to adjust the nominal values according to the selection.

16. The method of claim 15, wherein the variation scheme defines adjustments to the current waveform parameters relative to the nominal values of the current waveform parameters for each selectable setting over the dynamic range.

17. The method of claim 15, wherein:
the variation scheme is configured to cause the power supply to adjust one or more of the current waveform parameters linearly with the selectable settings over a portion of the dynamic range.

18. The method of claim 15, wherein:
the dynamic range includes a negative range that includes negative settings and a positive range that includes positive settings that straddle a zero setting corresponding to the nominal setting.

19. The method of claim 18, wherein the variation scheme is configured to adjust:
a first current waveform parameter over only the negative range; and
a second current waveform parameter over only the positive range.

20. The method of claim 15, wherein:
the variation scheme defines adjustments of the current waveform parameters for each selectable setting so as maintain a constant power of the pulsed current waveform for each selectable setting across the dynamic range.
